(19) United States
(12) Patent Application Publication
(10) Pub. No.: US 2004/0185131 A1
(43) Pub. Date: Sep. 23, 2004

(54) Cotton candy machine with tubular heater

(75) Inventor: Ronald R. Weiss, Okeana, OH (US)

Correspondence Address: WOOD, HERRON & EVANS, LLP, 2700 CAREW TOWER, 441 VINE STREET, CINCINNATI, OH, 45202, US

(73) Assignee: Gold Medal Products Company

(21) Appl. No.: 10/392,263

(22) Filed: Mar. 18, 2003

(51) Int. Cl. B28B 1/54

(52) U.S. Cl. 425/8

(57) ABSTRACT

A cotton candy machine includes a tubular heater and a slotted spinning band. The spinning band is disposed proximate the heater for receiving sufficient heat therefrom to melt sugar on the band. The slots are configured to effectively prevent unmelted sugar from passing through the slots when the band is heated. The slots may be laser cut into the spinning band.

### FIELD OF THE INVENTION

This invention relates to cotton candy machines and in particular to improved heated spinner heads for cotton candy machines.

### BACKGROUND OF THE INVENTION

Various structures have been used in making cotton candy. Basically, sugar is melted and the molten sugar flung out through a perforated member to define filaments which intermingle and form the candy. Typically, sugar in granular form is fed into a spinning housing. The centrifugal forces urge the sugar toward a surrounding heater where it is melted, then spun out into a collection pan. The nature and construction of the heater and of the perforated member or band noted above is significant in the efficiency of the process and the quality of the cotton candy produced.

For example, in one prior art cotton candy machine, a tubular or rod-like heater was oriented in a circle. Sugar engaging the tube was melted, then spun out through large holes in a band or screen. In this device, the heating of the sugar occurred due to its contact with the heater;

the holes in the band were large and the cotton candy produced was inconsistent and tended to be coarse, or with a prickly taste or feel. Grains of sugar could exit the band without being fully melted.

In another prior cotton candy machine using a tubular heater, a flyscreen was oriented proximate the heater to prevent sugar grains from escaping without being melted. Molten sugar exited the flyscreen, then was spun out through a cage with large holes. The flyscreen was fine enough to prevent passage of unmelted sugar granules.

In yet another prior cotton candy machine, a heater band made of wound strip heater elements with small passages through the winding served both to heat the sugar and prevent unmelted granules from escaping. The molten sugar was then spun out through a perforated band.

In prior cotton candy machines where the cages or screens had relatively large openings, use of relatively coarse sugar was required; the unmelted granules had to be large enough to avoid passage through the cage openings. Such coarser sugar was not as generally and easily available as is the normal table-type sugar now readily available.

It has thus become desirable to provide a cotton candy machine using a rod or tubular heater which efficiently makes high quality cotton candy from relatively small grain readily available sugar.

Another objective of the invention has been to provide an improved cotton candy machine having a tubular heater but without a flyscreen for preventing unmelted sugar from exiting the spinner head, yet producing fine, non-granular cotton candy.

### SUMMARY OF THE INVENTION

The present invention overcomes the foregoing and other shortcomings and drawbacks of heated spinner heads for cotton candy machines heretofore known. While the invention will be described in connection with certain embodiments, it will be understood that the invention is not limited to these embodiments. On the contrary, the invention includes all alternatives, modifications and equivalents as may be included within the spirit and scope of the present invention.

To these ends, an improved cotton candy machine is provided with a spinner head having a tubular heater disposed in an annular configuration inside a cylindrical spinning band having a plurality of inclined slots in its cylindrical surface. In accordance with one embodiment, each slot has a width approximately in the range of about 0.010″ to about 0.030″ and has a length sufficient for the size of tubular heater used in the spinner head. The heater and band are operatively disposed in the spinner head having a sugar receiving cavity. Sugar of readily available table variety is introduced into the sugar receiving cavity of the spinner head so sugar is urged outwardly toward the heater and spinning band.

The heater is operatively disposed close enough to the spinning band to cause it to heat sufficiently to melt any sugar granules passing the tubular heater unmelted and onto the band. Effectively all sugar is melted and passes as a molten fiber through the slots in the spinning band and outwardly where the filaments are collected to form a tasteful cotton candy.

The combination of the rod-like tubular heater and the particularly formed spinning band and slots so proximate the heater for heating of the band to melt sugar produces high quality cotton candy from regular, readily available fine grain sugar.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a front elevational view of a cotton candy machine incorporating a tubular heater and a slotted spinning band disposed within a spinner head in accordance with the principles of the present invention;

FIG. 2 is a perspective view of the tubular heater and spinning band of the spinner head shown in FIG. 1; and

FIG. 3 is a cross-sectional view taken along line 3-3 of FIG. 2.

### DETAILED DESCRIPTION OF THE INVENTION

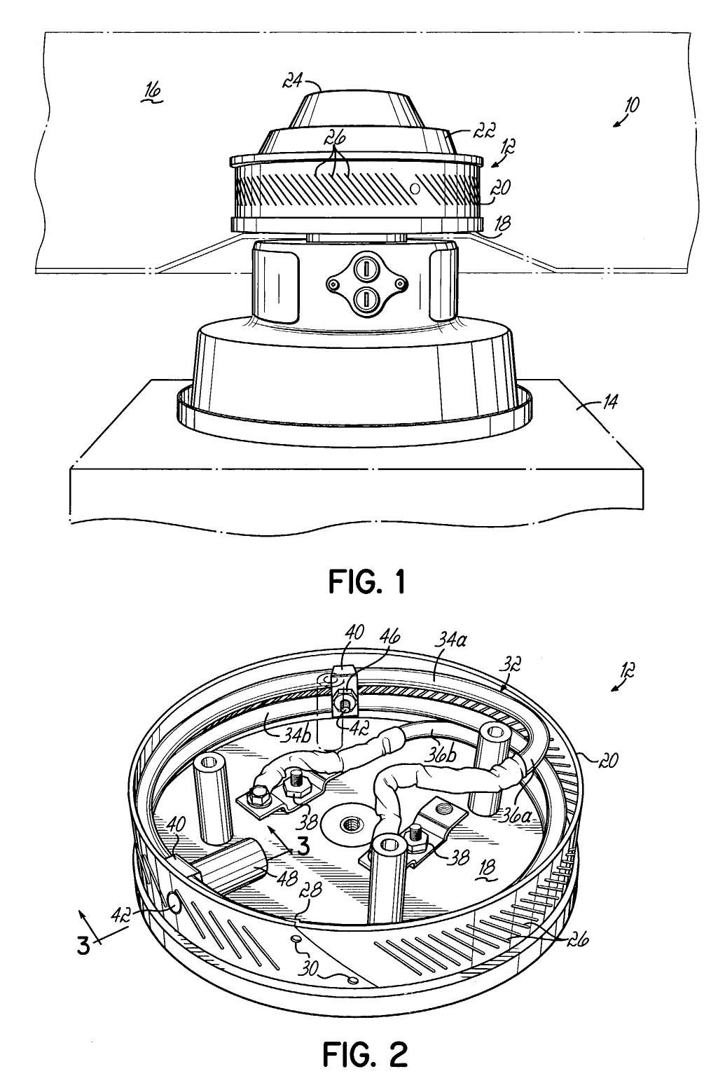

Referring now to FIG. 1, a cotton candy machine 10 is shown incorporating a heated spinner head 12 in accordance with the principles of the present invention. The cotton candy machine includes a base 14 and an accumulating tub 16 for collecting elongated strands or fibers of cotton candy as the fibers move outwardly by centrifugal force from the heated spinner head 12 mounted within the tub 16 as is well known in the art.

In one embodiment, the spinner head 12 includes a base plate 18, a cylindrical spinning band 20 supported on the base plate 18 and a spinner cap 22 supported on the spinning band 20. The spinner head 12 defines a cavity for receiving raw sugar granules which are poured through an opening 24 in the spinner head 12. A motor (not shown) in the base 14 of the machine 10 is operatively connected to the spinner head 12 so that the head 12 rotates to cast or spin molten sugar from slots 26 formed in the heated cylindrical spinning band 20 of the head 12 to form cotton candy within the tub 16.

The spinner head 12 is the primary focus of the present invention and is shown in detail in FIG. 2. In accordance with one aspect of the present invention, the spinning band 20 is made of metal, such as stainless steel by way of example, and has a thickness approximately in the range of about 20 gauge to about 24 gauge, although other band thicknesses are possible as well without departing from the spirit and scope of the present invention.

In one embodiment of the present invention, the slots 26 are laser cut into the band 20, while the band 20 is flat, as a series of parallel, inclined slots 26, although other slot configurations are possible as well such as horizontal or vertical slots (not shown). After the slots 26 are formed in the flat band (not shown), the band is formed into a cylinder to form the spinning band 20 shown in FIGS. 1 and 2. As shown in FIG. 2, one end of the band 20 includes an offset portion 28, and the opposite end of the band 20 is spot welded at 30 to overlap the offset portion of the band 28.

In one embodiment of the present invention, the slots 26 have a width approximately in the range of about 0.010″ to about 0.030″, and may have a width of about 0.015″, although other slot widths are possible as well. In accordance with the principles of the present invention, the slots 26 are configured to effectively prevent unmelted sugar granules from passing through the slots 26 when the band 20 is heated, but are large enough to permit the flow or spinning of viscous molten sugar through the slots 26 as the spinner head 12 rotates as will be described in greater detail below.

In accordance with another aspect of the present invention, as shown in FIG. 2, a tubular heater 32 is mounted within the spinner head 12 and has two (2) heater turns 34a and 34b of annular configuration which may have an outer diameter of about 5½″, although other diameters of the turns 34a, 34b, such as up to 8½″, and number of turns 34a, 34b are possible as well. The tubular heater 32 may have a cross sectional diameter of about 3/16″, although other cross sectional diameters of the tubular heater 32 are possible as well. As shown in FIG. 2, cold joints 36a and 36b of the tubular heater 32 are connected to terminals 38 which in turn are connected to annular electrical slip rings (not shown) mounted for rotation with the spinner head 12. Electrical, spring-loaded brushes (not shown) are mounted beneath the head 12 for engaging the annular slip rings (not shown) and conducting electricity to the tubular heater 32 as the head 12 spins.

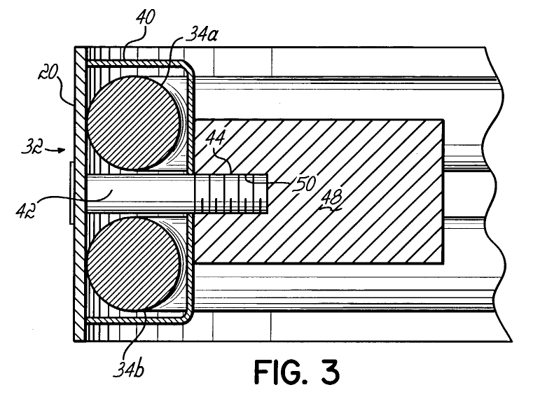

In accordance with the principles of the present invention, the spinning band 20 is disposed about an outer circumference of the tubular heater 32. As shown in FIGS. 2 and 3, the heater 32 is supported proximate the spinning band 20 through channel-shaped clamps 40 which are spaced circumferentially about an inner surface of the band 20. As shown in FIG. 3, threaded studs 42 pass through the band 20 to engage threaded apertures 44 formed in the clamps 40. Nuts 46 (FIG. 2) thread to the threaded ends of the studs 42 so that the clamps 40 support the turns 34a, 34b of the heater 32. In this way, the spinning band 20 is mounted proximate the heater 32 for receiving sufficient heat from the heater 32 to melt sugar which may pass through the heater 32 and onto the band 20. Of course, alternative mounting of the band 20 and the heater 32 is possible as well as will be appreciated by those of ordinary skill in the art.

As shown in FIG. 3, a counterweight 48 is mounted interior of the spinning band 20 through one of the threaded studs 42 which engages a threaded bore 50 within the counterweight 48. The counterweight 48 is mounted opposite the cold joints 34a, 34b of the tubular heater 32 and is provided to balance the spinner head 12 in the event unmelted raw sugar granules collect near the cold joints 34a, 34b before they migrate toward the heater 32 and heated band 20.

In use, raw granulated sugar is poured into the cavity of the spinner head 12 through the opening 24. Due to the advantages of the present invention, and in particular the configuration and mounting of the tubular heater 32 and the slotted spinning band 20, the sugar may be regular, readily available fine grain sugar, such as normal table-type sugar now readily available. The sugar can be poured into the spinner head 12 while it is either still or while it is moving.

Preferably, the sugar is poured during continuous operation, for example, when the spinner head 12 is rotating and when the tubular heater 32 is energized to heat the spinning band 20, so that as the sugar is poured into the spinner head 12, the centrifugal force of the spinner head 12 urges the sugar outwardly through the heater 32 and through the heated spinning band 20. The sugar is melted by the heater 32 and heated spinning band 20, and flows through the slots 26 of the spinning band 20 in the form of molten elongated strands or fibers where it accumulates as cotton candy in the tub 16. The cotton candy is then gathered on a stick or rolled paper tube for service and consumption as is known.

In accordance with the principles of the present invention, the combination of the tubular heater 32 and the particularly formed spinning band 20 and slots 26 so proximate the heater 32 for heating of the band 20 to melt the sugar produces high quality cotton candy from regular, readily available fine grain sugar. The heater 32 is operatively disposed close enough to the spinning band 20 to cause it to heat sufficiently to melt any sugar granules passing the tubular heater 32 unmelted and onto the heated band 20. Effectively all sugar is melted and passes as molten fibers through the slots 26 in the spinning band 20 and outwardly where the filaments are collected to form a tasteful cotton candy.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

What is claimed is:

1. A cotton candy machine, comprising:
a tubular heater; and
a cylindrical spinning band disposed proximate said heater for receiving sufficient heat therefrom to melt sugar on said band and having a plurality of slots formed therethrough configured to effectively prevent unmelted sugar granules from passing through said slots when said band is heated.

2. The cotton candy machine of claim 1 wherein said slots have a width approximately in the range of about 0.10″ to about 0.30″.

3. The cotton candy machine of claim 1 wherein said tubular heater has an annular configuration and wherein said band is disposed about an outer circumference of said heater.

4. The cotton candy machine of claim 1 wherein said band has a thickness approximately in a range of about 20 gauge to about 24 gauge.

5. A cotton candy machine, comprising:
a tubular heater having an annular configuration;
a cylindrical spinning band disposed proximate said heater for receiving sufficient heat therefrom to melt sugar on said band;
said band having a plurality of slots formed therethrough having a width approximately in a range of about 0.10″ to about 0.30″ and a band thickness approximately in a range of about 20 gauge to about 24 gauge.

6. The cotton candy machine of claim 5 wherein said band is disposed about an outer circumference of said heater.

7. The cotton candy machine of claim 5 further comprising a counterweight supported by said band.

8. A spinning band for use in a spinner head of a cotton candy machine, comprising:
a cylindrical band having a plurality of slots formed therethrough;
each of said slots having a width approximately in a range of about 0.10″ to about 0.30″.

9. The spinning band of claim 8 wherein said band has a thickness approximately in the range of about 20 gauge to about 24 gauge.

10. A method of making a spinning band for use in a spinner head of a cotton candy machine, comprising:
laser cutting a plurality of slots in a metal band; and
forming the metal band into a cylinder to form the spinning band.

11. The method of claim 10 wherein the slots have a width approximately in a range of about 0.10″ to about 0.30″.

12. The method of claim 10 wherein the band has a thickness approximately in a range of about 20 gauge to about 24 gauge.
